(19) United States
(12) Patent Application Publication
(10) Pub. No.: US 2004/0226038 A1
(43) Pub. Date: Nov. 11, 2004

(54) Advertisement method in digital broadcasting

(76) Inventor: Mi Ae Choi, Incheon-si (KR)

Correspondence Address: BIRCH STEWART KOLASCH & BIRCH, PO BOX 747, FALLS CHURCH, VA, 22040-0747, US

(21) Appl. No.: 10/840,358

(22) Filed: May 7, 2004

(30) Foreign Application Priority Data
May 7, 2003 (KR) 10-2003-0028805

(51) Int. Cl. H04N 5/445; G06F 3/00; H04N 7/025; G06F 13/00; H04N 7/10

(52) U.S. Cl. 725/32; 725/35; 725/42

(57) ABSTRACT

Disclosed is an advertisement method in a digital broadcasting for facilitating digital broadcasting and fostering efficiency of advertisement in the digital broadcasting. A designated advertisement image is provided at the appointed time with reference to time data extracted from a broadcasting stream for a broadcasting program The advertisement image is either relevant or irrelevant to the broadcasting program. Also, the advertisement image can be displayed on an A/V broadcasting screen or on a data-broadcasting screen.

### BACKGROUND OF THE INVENTION

1. Field of the Invention

The present invention relates in general to a digital broadcasting, more particularly, to an advertisement method for facilitating digital broadcasting and fostering efficiency of advertisement in the digital broadcasting.

2. Discussion of the Background Art

In general, a digital television is defined as any TV set that can accept and display digital broadcasting that is transmitted as a digital signal on a screen.

Current digital broadcasting standards are divided into DASE Digital TV Application Software Environment) standard adopted by the U.S. and DVB-MHP Digital Video Broadcasting—Multimedia Home Platform) standard adopted by Europe.

The digital broadcasting receives a TS (Transport Stream) that provides audio/video (hereinafter it is referred to as A/V) broadcasting signals and digital broadcasting signals.

As shown in FIG. 1, A/V broadcasting signals and digital broadcasting signals can be displayed on the screen at the request of televiewers. In FIG. 1, the screen 1 is divided into two sections: an A/V broadcasting screen 3 and a digital broadcasting screen 5. At this time, A/V broadcasting signals are displayed on the A/V broadcasting screen 3 and digital broadcasting signals are displayed on the digital broadcasting screen 5.

In particular, FIG. 1 illustrates a case where a viewer requested a data broadcasting and thus, old A/V broadcasting signals as well as digital broadcasting signals are displayed on the screen. Typically though, only A/V broadcasting signals are displayed in such case.

In the digital broadcasting a present stream event is used to execute a corresponding application (e.g., a scene of a television quiz show, in which a contestant reacts with cheers when he finds out his answer was correct). In other words, the stream event is a digital service that generates an event periodically or at a time. Usually a broadcasting station provides the stream event and processes a corresponding motion to a certain reaction of a user.

However, a related art digital broadcasting does not provide a variety of data broadcasting contents to attract more viewers to get interested. That is to say, right now viewers only watch A/V broadcastings and request a data broadcasting once in a while, usually for playing games or shopping. These broadcasting contents are not very attractive to most viewers and as a result, digital broadcasting has not yet settled down among the television viewers.

### SUMMARY OF THE INVENTION

An object of the invention is to solve at least the above problems and/or disadvantages and to provide at least the advantages described hereinafter.

Accordingly, one object of the present invention is to solve the foregoing problems by providing an advertisement method in digital broadcasting for facilitating digital broadcasting and fostering efficiency of advertisement in the digital broadcasting.

The foregoing and other objects and advantages are realized by providing an advertisement method in a digital broadcasting, the method including the steps of: extracting time data from a broadcasting stream for a broadcasting program; generating a designated advertisement event with reference to the extracted time data; and providing an advertisement image in connection with the generated advertisement event.

In an exemplary embodiment, the step for generating the designated advertisement event includes the sub-steps of: comparing the extracted time data with advertisement event occurrence time data that is received together with the advertisement image; and if the extracted time data coincides with the advertisement event occurrence time data, generating the designated advertisement event.

Another aspect of the invention provides an advertisement method in a digital broadcasting program, the method including the steps of: transmitting, in a transmitter, a broadcasting stream for a broadcasting program; extracting, in a receiver, time data from the broadcasting stream for the broadcasting program; transmitting, in the transmitter, advertisement information; determining, in the receiver, whether the extracted time data coincides with advertisement event occurrence time data included in the advertisement information; if the extracted time data coincides with the advertisement event occurrence time data, generating a designated advertisement event; and providing an advertisement image included in the advertisement information, in accordance with the generated advertisement event.

In an exemplary embodiment, the receiver confirms if the advertisement information is related to the broadcasting program before determining whether the extracted time data coincides with the advertisement event occurrence time data,

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates a scene displayed in a related art digital broadcasting;

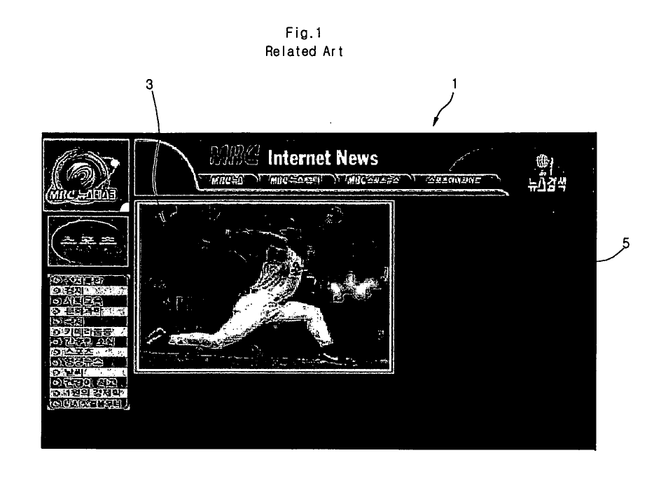

FIG. 2 describes how an advertisement is provided to a digital broadcasting, in accordance with a preferred embodiment of the present invention;

FIG. 3 is a flow chart describing an advertisement method in a digital broadcasting from a receiver's perspective, in accordance with a preferred embodiment of the present invention; and

FIG. 4 illustrates an advertisement image displayed in a digital broadcasting, in accordance with a preferred embodiment of the present invention.

### DETAILED DESCRIPTION OF PREFERRED EMBODIMENTS

The following detailed description will present an advertisement method in a digital broadcasting according to a preferred embodiment of the invention in reference to the accompanying drawings.

Before discussing the advertisement method of the invention, it will be appropriate for providing general information about a stream event applied to the invention.

As already explained before, a digital broadcasting based on European DVB-MHP standard provides a stream event for generating an event. Meanwhile, a digital broadcasting based on the U.S. DASE U.S. standard provides a trigger. That is, when a transmitter (a broadcasting station for example) transmits an event ID, event occurrence time and event contents by using a defined stream event descriptor (StrearnEventDescriptor( )), a receiver (a set-top box for example) interprets the data and generates a corresponding stream event to execute a desired application.

According to the advertisement method of the present invention, a descriptor for an advertisement event is defined on the basis of the descriptor for the stream event, and using the descriptor for the advertisement event designated advertisement information is transmitted to a receiver. Then, the receiver generates a corresponding advertisement event and provides an advertisement image. To be short, advertisement information to be transmitted is defined by the descriptor for the advertisement event.

Here, the descriptor for the advertisement event is defined as follows:

| | |
|---|---|
| Ad_StreamEventDescriptor(){ | |
| DescriptorTag | :8bit |
| DescriptorLength | :8bit |
| AdEventId | :16bit |
| Reserved | :31bit |
| Ad_Event NPT | :33bit |
| For(i=0;i<N;i++){ | |
| PrivateDataByte | :8bit |
| } | |
| } | |

“DescriptorTag” indicates a tag for identifying each descriptor, “DescriptorLength” indicates total bytes of a descriptor data portion; “AdEventId” indicates an advertisement event ID; and “Ad_Event NPT” indicates advertisement event occurrence time; and “PrivateDataByte” indicates an advertisement image.

Therefore, by using the descriptor defined for the advertisement event, a transmitter transmits an A/V broadcasting signal and advertisement information to the receiver. Here, the A/V broadcasting signal is transmitted in the form of a broadcasting stream.

The receiver generates an advertisement event based on the time data (NPT: Normal Play Time) extracted from the transmitted broadcasting stream and provides a corresponding advertisement image on the screen.

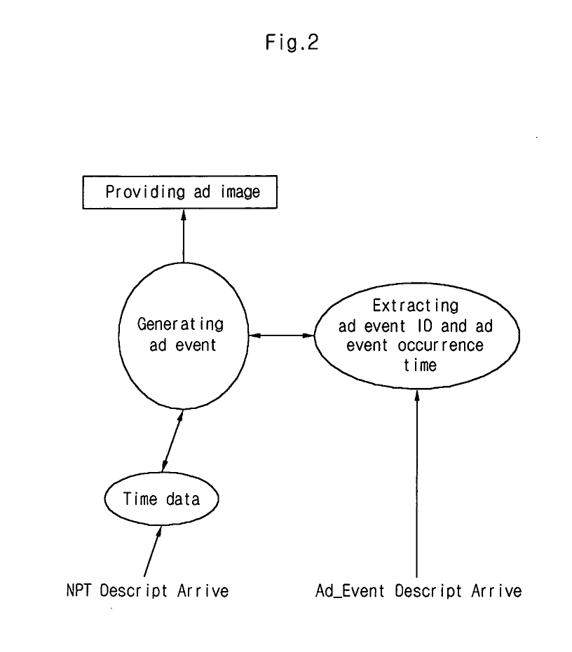

As illustrated in FIG. 2, the receiver extracts time data from the broadcasting stream provided from the transmitter and extracts an AdEventId and Ad_Event NPT from the advertisement information.

The NPT can be extracted by the NPT descriptor being defined. Since the NPT descriptor is already well-known technology, it will not be detailed here.

It is important that the receiver knows which broadcasting program the broadcasting stream from the transmitter corresponds to.

Once the receiver knows the broadcasting program being concerned, he is able to determine whether the advertisement is related to the broadcasting program.

Preferably, when the broadcasting program is transmitted the advertisements related to the broadcasting program are transmitted at the same time.

If it turns out that the advertisement image is related to the broadcasting program, the receiver compares time data extracted from the broadcasting stream (NP“) to advertisement event occurrence time data (Ad_Event NPT). Out of this comparison is determined the advertisement event occurrence time.

In other words, when the NPT coincides with the Ad_Event NPT, the receiver generates an advertisement event for displaying a corresponding advertisement image. This means that after the broadcasting program starts, the corresponding advertisement is popped out during a particular scene of the broadcasting program.

As the advertisement event is generated, the corresponding advertisement image is displayed on the screen.

An advertisement method in the digital broadcasting of the present invention will now be explained below.

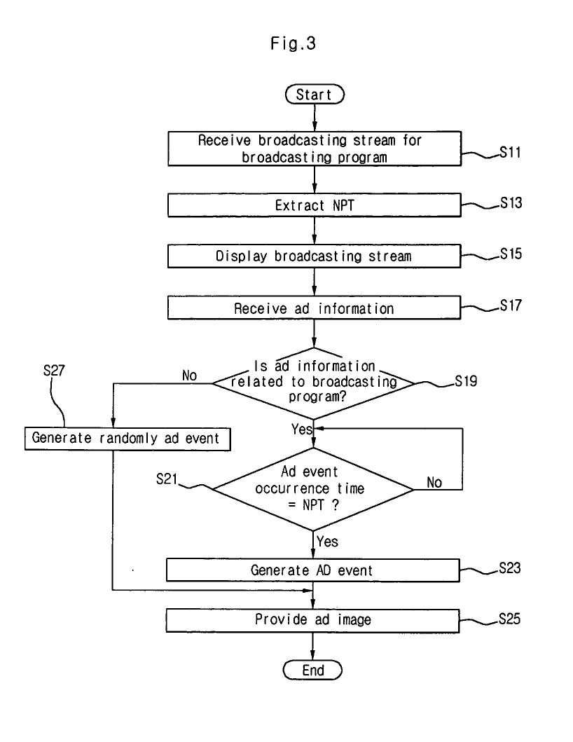

FIG. 3 is a flow chart describing the advertisement method in the digital broadcasting according to a preferred embodiment of the present invention.

Referring to FIG. 3, the receiver receives a broadcasting stream related to a broadcasting program provided by the transmitter (S11).

The broadcasting program is an A/V broadcasting signal like soap opera, sports, entertainment, news, documentary and so forth.

Then the receiver extracts time data from the transmitted broadcasting stream (NPT) (S13). Here, time data means the time included in each frame of the broadcasting stream. Preferably, the receiver also extracts a broadcasting program ID from the broadcasting stream.

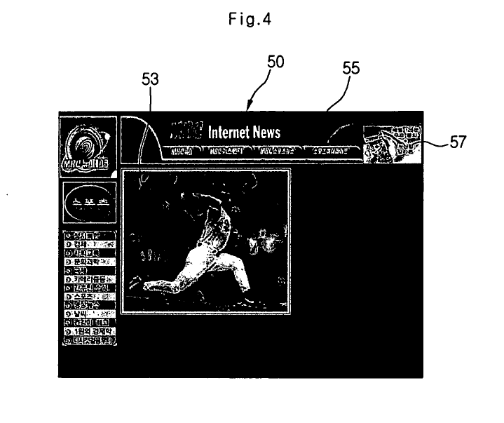

The NPT-extracted broadcasting stream is displayed on the screen (S15). At this time the broadcasting stream for the broadcasting program and the transmitted data broadcasting signal can be displayed at the same time (please refer to FIG. 4).

The receiver receives advertisement information provided by the transmitter (S17). The advertisement information and the broadcasting stream for the broadcasting program can be received at a time, or the advertisement information can be transmitted after the broadcasting stream for the broadcasting program is transmitted with the passage of time. That is to say, the receiver can receive the advertisement information during the broadcasting program

The transmitter transmits to the receiver the advertisement information by using a pre-defined advertisement event descriptor.

The advertisement information provided to the receiver by the transmitter contains advertisement event ID, advertisement event occurrence time and advertisement image.

After extracting the above data out of the advertisement information, the receiver decides whether the advertisement information is related to the broadcasting program (S19).

The receiver makes the decision by comparing the broadcasting program ID with the advertisement event ID. For example, if the broadcasting program ID is for a TV miniseries “All-In” (One of Korean TV miniseries that was popular in 2003), the receiver determines whether the advertisement event ID corresponds to the ID for the “All-In” or the ID for a sports program.

If it turns out that the advertisement information is related to the broadcasting program, the user determines whether the advertisement event occurrence time coincides with the time data (NPT) continuously extracted from the broadcasting stream (S21).

The advertisement event is generated only if the advertisement event occurrence time coincides with the NPT (S23).

When the advertisement event is generated, the receiver provides the advertisement image extracted from the advertisement information (S25).

The comparison of the advertisement event occurrence time with the NPT is necessary to enable the receiver to provide a corresponding advertisement image to a particular scene during the broadcasting program.

Suppose that there is an advertisement for a necklace worn by a main actress (Ms. Song Hae Gyo) of the TV miniseries “All-In”. The necklace advertisement can be provided every time the main actress shows on the screen. To enable the receiver to provide the corresponding advertisement every time the main actress appears, the transmitter provides the receiver with the advertisement information based on the advertisement event descriptor, the advertisement information including advertisement event ID, advertisement even occurrence time and advertisement image. Preferably, the advertisement information is transmitted to the receiver before the main actress appears on the screen.

Then the receiver extracts advertisement event occurrence time from the advertisement information and displays the necklace advertisement image on the screen whenever the main actress appears on the screen.

On the other hand, if it turns out that the advertisement information is not related to the broadcasting program (S19), the receiver generates randomly an advertisement event (S27). This case is where the advertisement content is irrelevant to the broadcasting program. That is, the advertisement image included in the advertisement information has nothing to do with the broadcasting program and thus, the receiver generates randomly an advertisement event according to a predetermined time data or generates an advertisement periodically/at a time.

Whenever the advertisement event is generated periodically or at a time, a corresponding advertisement image to the advertisement event is provided.

Referring to FIG. 4, a screen 50 is divided into two sections: an A/V broadcasting screen 53 for displaying a broadcasting program and a data broadcasting screen 55 for displaying a data broadcasting signal.

In particular, FIG. 4 illustrates that a baseball game in which Park Chan Ho (a famous Korean baseball player in Texas Rangers team) took the mound is displayed on the A/V broadcasting screen 53 in real time mode, and a news data broadcasting signal for ‘MBC News Desk’ is displayed on the data broadcasting screen 55.

Although the advertisement information from the transmitter is not related to the baseball game, the advertisement image 57 (e.g., cellular phone advertisement) can be displayed on a certain position of the data broadcasting screen 55.

Therefore, the advertisement method of the invention enables the receiver to provide the corresponding advertisement image to the broadcasting program whether the advertisement image is related to the broadcasting program.

Although the embodiment illustrated in FIG. 4 involves displaying the advertisement image on the data broadcasting screen 55, if necessary the advertisement image can also be displayed on the A/V broadcasting screen 53 where the related broadcasting program is displayed.

In conclusion, the advertisement method in the digital broadcasting according to the present invention can be advantageously used for displaying the advertisement image on the screen of the digital television set capable of providing digital broadcasting services.

In addition, the present invention enables to provide to the advertisement image related to the broadcasting program that is on the air at the moment.

The advertisement image can be displayed not only on the data-broadcasting screen but also on the A/V broadcasting screen.

The advertisement efficiency is maximized by placing the advertisement on the television many viewers use.

Also, advertisement profits thereof will be steadier and this eventually will promote digital broadcasting more aggressively.

while the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An advertisement method in a digital broadcasting, the method comprising the steps of:
extracting time data from a broadcasting stream for a broadcasting program;
generating a designated advertisement event with reference to the extracted time data; and
providing an advertisement image in connection with the generated advertisement event.

2. The method according to claim 1, wherein the time data indicates a time included in each frame that constructs the broadcasting stream.

3. The method according to claim 1, wherein generating the designated advertisement event comprises the steps of:
comparing the extracted time data with advertisement event occurrence time data that is received together with the advertisement image; and
if the extracted time data coincides with the advertisement event occurrence time data, generating the designated advertisement event.

4. The method according to claim 1, wherein the advertisement image is received when the broadcasting program is on the air.

5. The method according to claim 1, wherein the advertisement image and the broadcasting stream for the broadcasting program are received simultaneously.

6. The method according to claim 1, wherein the advertisement image is related to the broadcasting program.

7. The method according to claim 1, wherein the advertisement image is not related to the broadcasting program.

8. The method according to claim 7, wherein if the advertisement image is not related to the broadcasting program, the advertisement image is provided randomly.

9. The method according to claim 7, wherein if the advertisement image is not related to the broadcasting program, the advertisement image is provided periodically.

10. The method according to claim 1, wherein the advertisement image is displayed at a designated position on an A/V broadcasting screen.

11. The method according to claim 1, wherein the advertisement image is displayed at a designated position on a data-broadcasting screen.

12. An advertisement method in a digital broadcasting program, the method comprising the steps of:
transmitting, in a transmitter, a broadcasting stream for a broadcasting program;
extracting, in a receiver, time data from the broadcasting stream for the broadcasting program;
transmitting, in the transmitter, advertisement information;
determining, in the receiver, whether the extracted time data coincides with advertisement event occurrence time data included in the advertisement information;
if the extracted time data coincides with the advertisement event occurrence time data, generating a designated advertisement event; and
providing an advertisement image included in the advertisement information, in accordance with the generated advertisement event.

13. The method according to claim 12, wherein the advertisement information and the broadcasting stream for the broadcasting program are transmitted simultaneously.

14. The method according to claim 12, wherein the advertisement information is transmitted a certain period of time after the broadcasting stream for the broadcasting program is transmitted.

15. The method according to claim 12, wherein the advertisement information is transmitted to the receiver by using an advertisement event descriptor that is pre-defined by the transmitter.

16. The method according to claim 12, wherein before determining whether the extracted time data coincides with the advertisement event occurrence time data, the receiver confirms if the advertisement information is related to the broadcasting program.

17. The method according to claim 16, wherein if the advertisement information is related to the broadcasting program, the receiver determines whether the extracted time data coincides with the advertisement event occurrence time data.

18. The method according to claim 16, wherein if the advertisement information is not related to the broadcasting program, the receiver provides an advertisement image included in the advertisement information, in accordance with an advertisement event that is generated randomly.

19. The method according to claim 16, wherein if the advertisement information is not related to the broadcasting program, the receiver provides an advertisement image included in the advertisement information, in accordance with an advertisement event that is generated periodically.
